(19) United States
(12) Patent Application Publication
(10) Pub. No.: US 2007/0095180 A1
(43) Pub. Date: May 3, 2007

(54) CUTTING METHOD FOR DWDM FILTER AND DWDM FILTER MADE THEREBY

(75) Inventors: Chen-Yi-Sheng Zhang, Taichung (TW); Fu-Cheng Bai, Taichung (TW); Jun-Liang Chen, Taichung (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: ASIA OPTICAL CO., INC., Taichung (TW)

(21) Appl. No.: 11/538,757

(22) Filed: Oct. 4, 2006

(30) Foreign Application Priority Data
Oct. 6, 2005 (TW) 094134968

(51) Int. Cl. B26D 1/00

(52) U.S. Cl. 83/13

(57) ABSTRACT

A method for cutting a DWDM filter from a substrate is disclosed, including a two-step process having an initial cutting step and a subsequent cutting step. The initial cutting step forms a slot on a substrate according to size requirement of a finished filter product. The slot has a width larger than the thickness of a cutter employed to perform cutting operation on the substrate. The subsequent cutting step, taken in the slot, completely cuts through the remaining thickness of the substrate to separate the filter from the substrate. The two-phase cutting process avoids corner breaking caused by direct contact between the cutter and the coating layers of the substrate.

### BACKGROUND OF THE INVENTION

1. Field of the Invention

The present invention relates generally to a method for cutting optical filter and filters made by the same, and more particularly to a cutting method for a dense wavelength division multiplexing (DWDM) filter, which includes a two-step process.

2. Description of the Prior Art

With the development of broadband telecommunication service, the demand for the transmittance volume of the backbone network is increasing; hence the technology of dense wavelength division multiplexing (DWDM), which can provide huge volume and diversity broadband service, is prospering accordingly.

The DWDM technology refers to a multiplexer which divides a wavelength or a group of wavelengths into a plurality of sub-wavelengths having much higher density, thereby allowing an optical fiber to transmit a plurality of signals instead of just one single signal. The efficiency of employing an optical fiber is thus greatly increased with the same cost of ground construction. Nowadays, there are mainly three methods for realizing DWDM, which are thin film filter (TFF), array wave guide (AWG), and fiber Bragg grating (FBG), among which TFF is most commonly employed.

TFF normally forms thin film on a substrate, such as glass substrate, by alternately coating layers of different refractivity on surfaces of the substrate with vapor deposition. The substrate that is coated with the thin film is then cut into flakes according to size requirement. When a light beam passes such a filter, different wavelengths will be separated from each other by the layers of the film thereby achieving division of the wavelengths. However, the film so formed is subject to excessive internal stress and subsequent processing, such as cutting, often causes corners of the film to break off. An example of such a corner-broken filter is shown in FIG. 1 and designated with reference numeral 90.

The broken corners may cause undesired consequence in the subsequent processing of the filter. For example, with reference to FIG. 2, to attach an optical filter to an end of a GRIN lens 91, glue 92 in liquid form is completely applied between the filter 90 and the end face of the GRIN lens 91. The liquid glue 92 often overflows the filter 90 and seeps into the broken corners of the filter 90. Once heated, the glue 92 that exists in the broken corners is subject to a greater amount of thermal expansion than the remaining portions thereby leading to non-uniform interfacing between the filter 90 and the GRIN lens 91. Poor quality of product is thus resulted.

### BRIEF SUMMARY OF THE INVENTION

An object of the present invention is, therefore, to provide a cutting method for a dense wavelength division multiplexing (DWDM) filter which aims to solve the above-mentioned problem caused by the corner breaking phenomenon.

In order to achieve the above object and to overcome the above-identified deficiencies in the prior art, the present invention provides a two-phase (two-step) cutting method, comprising a first step (phase one) wherein an initial cutting is performed with a cutter of a predetermined thickness on a film-coated substrate to form a slot on the substrate, whose width is double of the thickness of the cutter, according to the size requirement of a finished filter, and a second step (phase two) wherein a subsequent cutting is performed on the bottom of the slot to completely cut through the substrate.

Compared with the prior arts, the cutting method in accordance with the present invention cuts the film-coated substrate by two separate cutting steps thereby effectively preventing corner breaking from occurring during the cutting process. Thus, product quality of the optic filter and an optical filter system comprised of the filter can be ensured. Moreover, the cutting method of the present invention also has the advantage of easy operation.

Other objects, advantages, and novel features of the invention will become more apparent from the following detailed description of a preferred embodiment when taken in conjunction with the accompanying drawings.

### BRIEF DESCRIPTION OF THE DRAWINGS

The present invention may best be understood through the following description with reference to the accompanying drawings, in which:

FIG. 1 is a schematic view showing an optical filter made by a conventional cutting method;

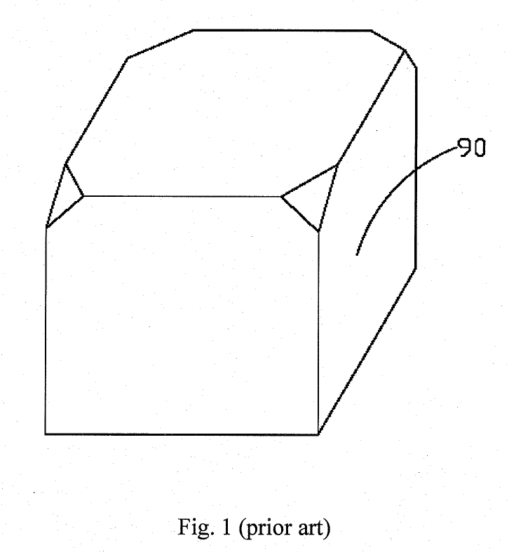

FIG. 2 is a schematic view showing mounting the conventional filter of FIG. 1 to a GRIN lens to demonstrate the drawbacks caused by corner breaking of a thin film coated on the filter;

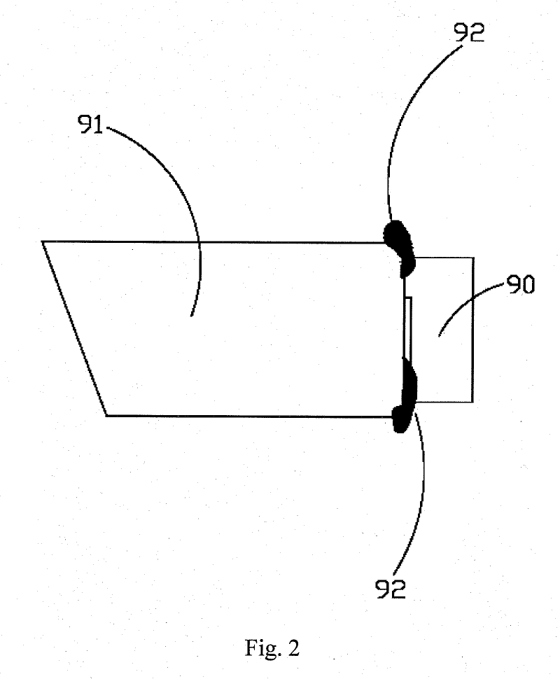

FIG. 3 is a schematic view of a filter substrate cut by an initial cutting step of a cutting method in accordance with the present invention;

FIG. 4 is a schematic view illustrating the operation of a subsequent cutting step of the cutting method of the present invention;

FIG. 5 is a schematic view, observed from the side thereof, of an optical filter made by the cutting method in accordance with the present invention;

FIG. 6 is a schematic view, observed from the top thereof, of the optical filter of FIG. 5; and

FIG. 7 is a schematic view demonstrating mounting the optical filter made in accordance with the present invention to a GRIN lens.

### DETAILED DESCRIPTION OF THE INVENTION

Reference will now be made in detail to a preferred embodiment of the present invention.

The cutting method of the present invention is a process comprising two steps or phases, among which, step 1 (phase one) is an initial cutting step that forms a slot in a substrate 1, such as a glass substrate, which is used to form a finished optical filter later. The width of the slot is double or more of the thickness of the cutter, depending upon the final size of the finished optical filter. Step 2 (phase two) is a subsequent cutting step preformed in the slot to completely cut through the whole thickness of the substrate.

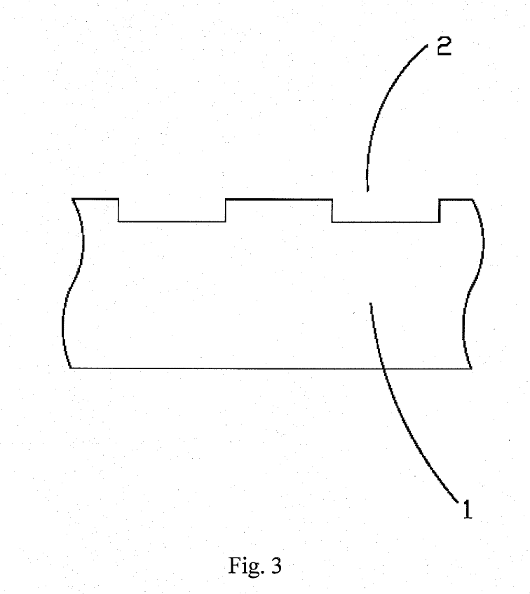

Referring to FIGS. 3-5, a substrate, which is used to make for example an optical filter, is designated with reference numeral 1 in the drawings. The substrate 1 is a flat and thin glass plate having upper and bottom major surfaces on which films of high and low refractivity are alternately coated to form a thin film. It is noted that film and the coated layers are not shown, but can be imaged by those having ordinary skills in the arts.

As set forth above, cutting on the coated film induces internal stress in the film, which may cause corners of the film to break off. Therefore, in order to solve this problem, the cutting method of the present invention adopts a two-step cutting process comprised of a first step of initial cutting (phase one), which, as shown in FIG. 3, with the aid of a cutter having a predetermined thickness, forms a slot 2 along the array direction thereof according to the size requirements of the finished product. The slot 2 is formed by repeated feeding of the cutter to a predetermined depth whereby the width of the slot 2 is equal to or more than the double of the thickness of the cutter. It is noted that the cutter is omitted in the drawings. The cutting operation of the slot 2 is done with repeated feeding of the cutter, which means the cutter cuts out a plurality of slim slots in a side-by-side manner on the surface of the substrate 1. In other words, the slot 2 is composed of a plurality of slim slots that are arrayed closely side by side with edges thereof overlapping each other.

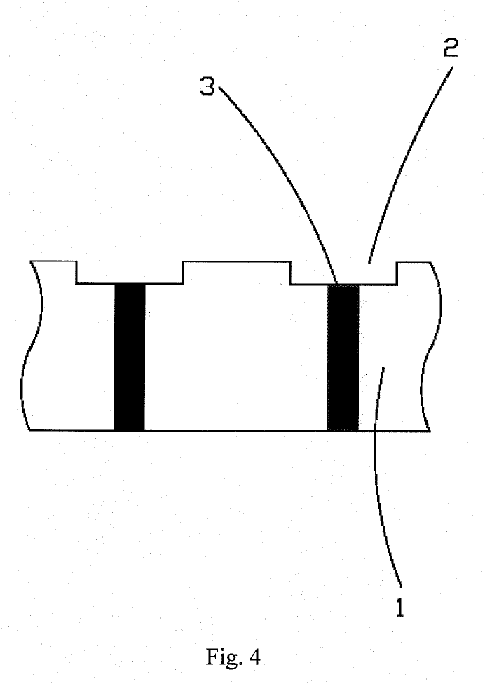

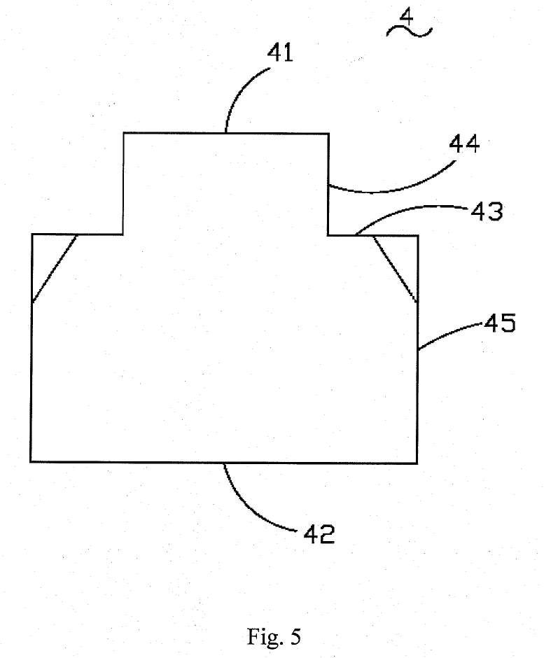

After the slot 2 is finished, the cutter is moved to a center point 3 of the slot 2 (see FIG. 4) and is made to completely cut through the substrate to carry out the second step of subsequent cutting (phase two) of the method in accordance with the present invention. In other words, the cutter is fed to cut into and through the remaining part of the substrate 1 under the slot 2 (as shown by the blackened part in FIG. 4) and then cut off the optical filter 4 (FIG. 5).

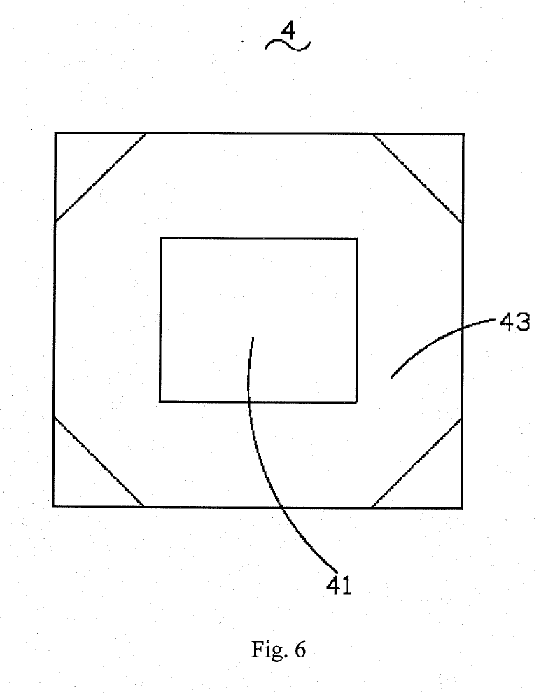

As shown in FIGS. 5 and 6, the filter 4 cut from the substrate 1 has a first major surface 41 and a second major surface 42 opposite to the first surface 41. The first and second surfaces 41, 42 respectively present upper and lower surfaces of the substrate 1. Hence, the first surface 41 is substantially parallel to the second surface 42 and the distance between the first and second surfaces 41, 42 (which will be referred to as “first distance”) is equal to the thickness of the substrate 1, plus a minor increment of the extreme small thickness of the thin films formed on the substrate 1.

In the embodiment illustrated, the slot 2 is made on the first surface 41 of the filter 4, which corresponds to the upper surface of the substrate 1. Therefore, a bottom surface 43 (hereinafter referred to as first adhibit face) of the slot 2 is generally parallel to the first surface 41 of the filter 4, although it is not necessary to be so, and at the same time surrounding the first surface 41 (as shown in FIG. 6). In other words, the first adhibit face 43 is formed by removing a portion of the material of the filter from the upper surface of the substrate 1. This makes the distance between the first adhibit face 43 and the second surface 42 (which will be referred to as “second distance”) is less than the first distance between the first surface 41 and the second surface 42.

A cutter having a predetermined thickness is made to cut into the upper surface of the substrate 1 in a direction generally normal to the upper surface (i.e., the first surface 41 of the filter 4) of the substrate 1, forming a plurality of slim slots closely arrayed side by side with the edges of slim slots overlapping each other. As a result, a surrounding surface 44 (hereinafter referred to as “first surrounding surface”) 44 is formed between the bottom 43 (i.e., the first adhibit face 43) of the slot 2 and the first surface 41, which is approximately perpendicular to both the first adhibit face 43 and the first surface 41. Similarly, when the cutter is made to cut completely through the substrate 1 to the second surface 42, another surrounding surface 45 (hereinafter referred to as “second surrounding surface”) is formed between the first adhibit face 43 and the second surface 42. Thus, the second surrounding surface 45 is formed due to the cutting operation of the cutter after the first adhibit face 43 is formed.

As the feeding direction of the cutter is generally perpendicular to the upper surface (i.e., the first surface 41) of the substrate 1 or the bottom surface (i.e., the second surface 42), the first surrounding surface 44 and the second surrounding surface 45, which are formed due to the feeding process of the cutter, are approximately parallel to each other on either of the sides of the filter 4. Moreover, the vertical distance between the first and second surrounding surfaces 44, 45 is theoretically half of the difference between the widths of the slot 2 minus the thickness of the cutter (the one when cutting through the substrate 1, which as shown in FIG. 4 is the width of the blacken part).

As mentioned previously, the width of the slot 2 is at least the double of the thickness of the cutter. Therefore, the distance between the first and second surrounding surfaces 44, 45 is at least half of the thickness of the cutter. However, according to another embodiment of the present invention, the distance between the first and second surrounding surfaces 44, 45 is equal to or more than the thickness of the cutter. It is understood that the distance between the first and second surrounding surfaces 44, 45 is selected to avoid potential corner breaking problems caused when the cutter is made to cut through the substrate 1. Hence, as long as the cutter does not contact the first surface 41 of the filter 4, the distance between the first and second surrounding surfaces 45 does not need to be limited to any specific size.

Since in the second step, when cutting through the substrate 1, the cutter does not directly contact the coated surface (i.e., the first surface 41 in this embodiment) thereby the coating layers or film thereon will not be damaged. This can effectively addresses the corner breaking of the filter 4. However, the cutter will still contact the first adhibit face 43 during the cutting operation of the second step, it is also possible that corner breaking might occur at the area of the first adhibit face 43 adjoining to the second surrounding surface 45, just as shown by the broken lines in FIG. 5. However, such corner breaking presents no adverse effect for there is no coating layer on the first adhibit face 43.

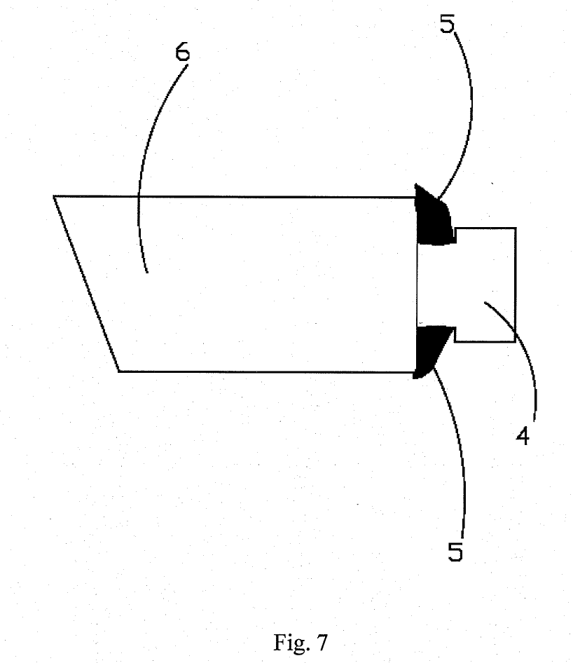

Also referring to FIG. 7, to assemble, glue 5 is applied to the whole end face of a GRIN lens 6 and the filter 4 and is possibly filled in the space delimited between the first adhibit face 43 and the first surrounding surface 44. Heat is then applied to cure the glue 5 to secure the filter 4 to the GRIN lens 6. As there is no corner breaking on the surfaces of the filter 4 (i.e., the first surface 41 in this embodiment), the filter 4 can then be closely attached to the GRIN lens 6 as a whole. This helps to prevent the glue 5 from causing the filter 4 to partly leave or tilt from the GRIN lens 6 due to excessive thermal expansion, which may lead to such problems as changes of optical routes and optical characteristics thereof.

The present invention adopts a process having two-phase cutting so as to avoid the previously mentioned corner breaking caused by direct contact between the cutter and the coating layers on the substrate 1 when the cutter is made to start cutting or is made to leave after finishing the cutting due to the inner stress factors of the coating layers thereof.

It is to be understood, however, that even though numerous characteristics and advantages of the present invention have been set forth in the foregoing description, together with details of the structure and function of the invention, the disclosure is illustrative only, and changes may be made in detail, especially in matters of material, plating method and manufacturing process within the principles of the invention to the full extent indicated by the broad general meaning of the terms in which the appended claims are expressed.

What is claimed is:

1. A method for cutting a substrate with a cutter having a thickness to form a product that is selectively and further processed to eventually form a DWDM filter, the method comprising the following steps:
(1) performing first cutting on the substrate to form a slot that has a width selected according to size requirement of the product and larger than the thickness of the cutter; and
(2) performing a second cutting in the slot to completely cut through the substrate.

2. The method as claimed in claim 1 further comprising a step of alternately forming a plurality of coating layers of high and low refractivity on at least one major surface of the substrate before step (1).

3. The method as claimed in claim 1, wherein the width of the slot is at least double the thickness of the cutter.

4. The method as claimed in claim 2, wherein the second cutting of step (2) is performed in such a way that the cutter does not contact the coating layers of the substrate.

5. A DWDM optical filter, comprising:
a first major face;
a second major face substantially parallel to the first major face and spaced from the first major face by a first distance;
a first adhibit face formed by removing portions of the filter from the first major face toward the second major face, whereby the first adhibit face surrounds the first major face and having a second distance from the second major face;
a first surrounding surface connecting the first adhibit face and the first major face; and
a second surrounding surface connecting the first adhibit face and the second major face;
wherein a specific distance is formed between the first and second surrounding surfaces, and the first adhibit face is formed by multiple cutting on the filter with a cutter having a desired thickness to a depth corresponding to the first adhibit face.

6. The DWDM optical filter as claimed in claim 5, wherein a plurality of coating layers with high and low refractivity are alternately coated on at least one of the first and second major faces.

7. The DWDM optical filter as claimed in claim 5, wherein the specific distance between the first and second surrounding surfaces is at least equal to the thickness of the cutter.

8. The DWDM optical filter as claimed in claim 5, wherein the specific distance between the first and second surrounding surfaces is greater than the thickness of the cutter.

9. The DWDM optical filter as claimed in claim 5, wherein the second surrounding surface is formed by cutting operation with the cutter after the first adhibit face is formed.
